(19) United States
(12) Patent Application Publication
(10) Pub. No.: US 2012/0034570 A1
(43) Pub. Date: Feb. 9, 2012

(54) SUBSTRATE PROCESSING APPARATUS AND METHOD OF MANUFACTURING SEMICONDUCTOR DEVICE

(75) Inventors: Takeshi YASUI, Toyama (JP); Naoya MATSUURA, Toyama (JP)

(73) Assignee: HITACHI KOKUSAI ELECTRIC INC., Tokyo (JP)

(21) Appl. No.: 13/193,220

(22) Filed: Jul. 28, 2011

(30) Foreign Application Priority Data
Aug. 4, 2010 (JP) 2010-175345
Jun. 13, 2011 (JP) 2011-130994

(51) Int. Cl. F26B 11/02; F27D 5/00

(52) U.S. Cl. 432/1; 432/253

(57) ABSTRACT

A substrate processing apparatus reduces over-heating of a substrate transfer robot and suppresses deterioration of reliability or lifespan of the substrate transfer robot. The substrate processing apparatus includes a transfer chamber having a substrate transferred thereinto under a negative pressure; a process chamber connected to the transfer chamber and configured to heat the substrate; a transfer robot installed in the transfer chamber and configured to transfer the substrate into and out of the process chamber; and a cooling unit configured to cool an inner wall of the transfer chamber.

### CROSS-REFERENCE TO RELATED APPLICATIONS

This application claims priority to and the benefit of Japanese Patent Application No. 2010-175345 filed on Aug. 4, 2010, and No. 2011-130994 filed on Jun. 13, 2011, the disclosures of which are incorporated herein by reference.

### FIELD OF THE INVENTION

The present invention relates to a substrate processing apparatus capable of effectively transferring a plurality of substrates when the plurality of substrates are continuously processed, and a method of manufacturing a semiconductor device.

### DESCRIPTION OF THE RELATED ART

For example, in a substrate processing apparatus such as a semiconductor manufacturing apparatus configured to perform a predetermined treatment on a semiconductor substrate, a plurality of process chambers are installed, and a substrate is subjected to film-forming treatment or heat treatment in each process chamber. Also, a substrate is transferred between the process chambers under a vacuum state, that is, a negative pressure, using a transfer robot.

### PRIOR-ART DOCUMENT

### Patent Document

1. Japanese Patent Laid-open Publication No.: 2010-153453

### SUMMARY OF THE INVENTION

In a process of manufacturing a semiconductor device executed in the substrate processing apparatus, many processes of processing a substrate at a high temperature are performed in a process chamber, and a transfer robot installed in the transfer chamber and configured to transfer the substrate receives thermal radiation from the processed substrate. Heat transfer between objects spaced apart under a negative pressure is predominantly performed by the thermal radiation. Therefore, as thermal absorptivity (corresponding to thermal emissivity) in surfaces of the objects is increased, a radiant heat is easily absorbed. An arm installed at the transfer robot to support the substrate is made of a material such as, for example, aluminum (Al), and is used after a surface of the arm is subjected to alumite treatment (anodic oxidation treatment of aluminum). A surface of the alumite is known to have a thermal absorptivity of approximately 0.7 to 0.9, and the transfer robot treated with the alumite is highly apt to absorb heat. Also, since the arm of the transfer robot is installed under a vacuum (negative-pressure) environment, and heat may not be easily radiated because the arm does not come into contact with other devices. Therefore, the absorbed heat is accumulated in the arm.

Also, as throughput required for the substrate processing apparatus is increased every year, a cycle of introducing the transfer robot into the process chamber in which a high-temperature substrate placing stage is installed, or a cycle of transferring a high-temperature substrate, is shortened. Accordingly, since a quantity of heat applied to the transfer robot is increased, the arm of the transfer robot is increased in temperature. Under an environment in which a pressure in the transfer chamber is 100 Pa, when 50 substrates heated to 700° C. are transferred per hour using the alumite-treated transfer robot, a temperature of the arm of the transfer robot may be increased to 120° C. or higher. As a result, it can be seen that drive parts configured to operate the transfer robot may be degraded, thereby deteriorating reliability or lifespan of the transfer robot. Also, it can be seen that, since the transfer robot is rapidly cooled while the substrate is transferred from the high-temperature process chamber to the low-temperature transfer chamber, parts constituting the transfer robot may be easily degraded.

The present invention is designed in consideration of such conventional circumstances, and an object of the present invention is to enhance a resistance of the transfer robot to environments such as high temperature, and suppress an increase in temperature of the transfer robot by manufacturing the transfer robot having a structure which may not easily absorb heat.

According to one embodiment of the present invention, there is provided a substrate processing apparatus including: a transfer chamber having a substrate transferred thereinto under a negative pressure; a process chamber connected to the transfer chamber and configured to heat the substrate; a transfer robot installed in the transfer chamber and configured to transfer the substrate into and out of the process chamber; and a cooling unit configured to cool an inner wall of the transfer chamber.

According to another embodiment of the present invention, there is provided a method of manufacturing a semiconductor device, including: (a) loading a substrate from a transfer chamber into a process chamber connected to the transfer chamber using a transfer robot installed in the transfer chamber, the transfer chamber having a substrate transferred thereinto under a negative pressure; (b) heating the substrate in the process chamber; and (c) unloading the substrate from the process chamber into the transfer chamber using the transfer robot, wherein, at least in step (c), the substrate is unloaded while an inner wall of the transfer chamber is cooled by a cooling unit.

A substrate processing apparatus and a method of manufacturing a semiconductor device according the present invention can suppress an increase in temperature of a transfer robot and improve manufacturing throughput of a substrate processing apparatus.

### BRIEF DESCRIPTION OF THE DRAWINGS

FIG. 1 is a longitudinal cross-sectional view illustrating a configuration example of a substrate processing apparatus according to one embodiment of the present invention.

FIG. 2 is a vertical cross-sectional view illustrating a configuration example of the substrate processing apparatus according to one embodiment of the present invention.

FIG. 3 is a diagram illustrating a configuration example of a process chamber and surroundings of the process chamber according to one embodiment of the present invention.

FIG. 4 is a diagram illustrating a configuration example of a vacuum transfer robot according to one embodiment of the present invention.

FIG. 5 is a diagram illustrating measurement results of each part of a vacuum transfer robot according to a first example of the present invention.

FIG. 6 is a diagram illustrating dependence of a mean temperature of each part of a vacuum transfer robot according to a second example of the present invention on a number of substrates processed per hour.

FIG. 7 is a diagram illustrating dependence of a mean temperature of each part of a vacuum transfer robot according to a third example of the present invention on a number of substrates processed per hour.

FIG. 8 is a diagram illustrating a configuration example of a refrigerant channel provided with a vacuum transfer chamber according to one embodiment of the present invention. Here, FIG. 8(a) is a longitudinal cross-sectional view of the vacuum transfer chamber, and FIG. 8(b) is a vertical cross-sectional view of the vacuum transfer chamber.

### DETAILED DESCRIPTION OF THE PREFERRED EMBODIMENTS

### (1) Configuration of Substrate Processing Apparatus

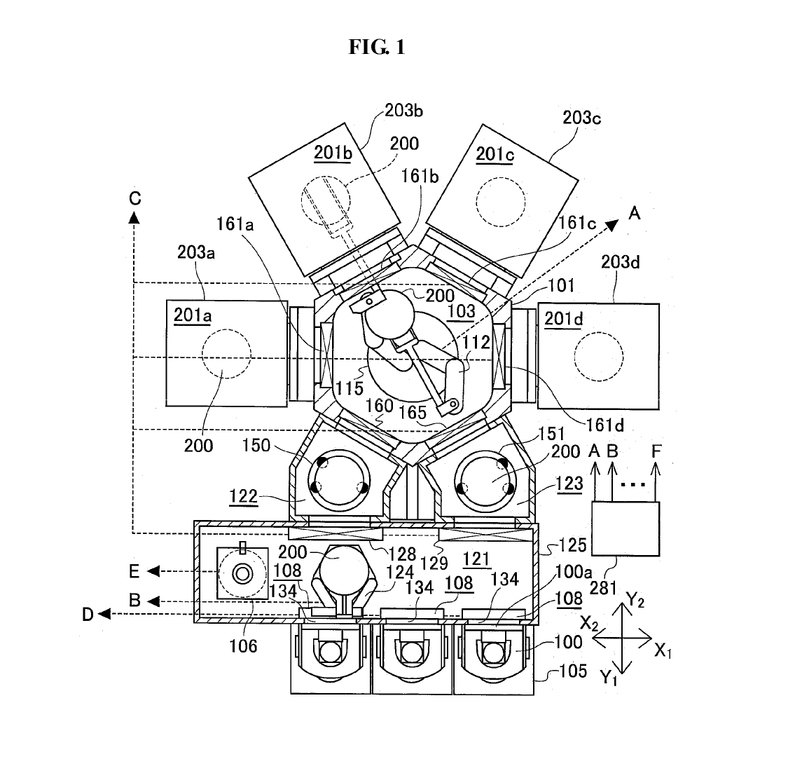

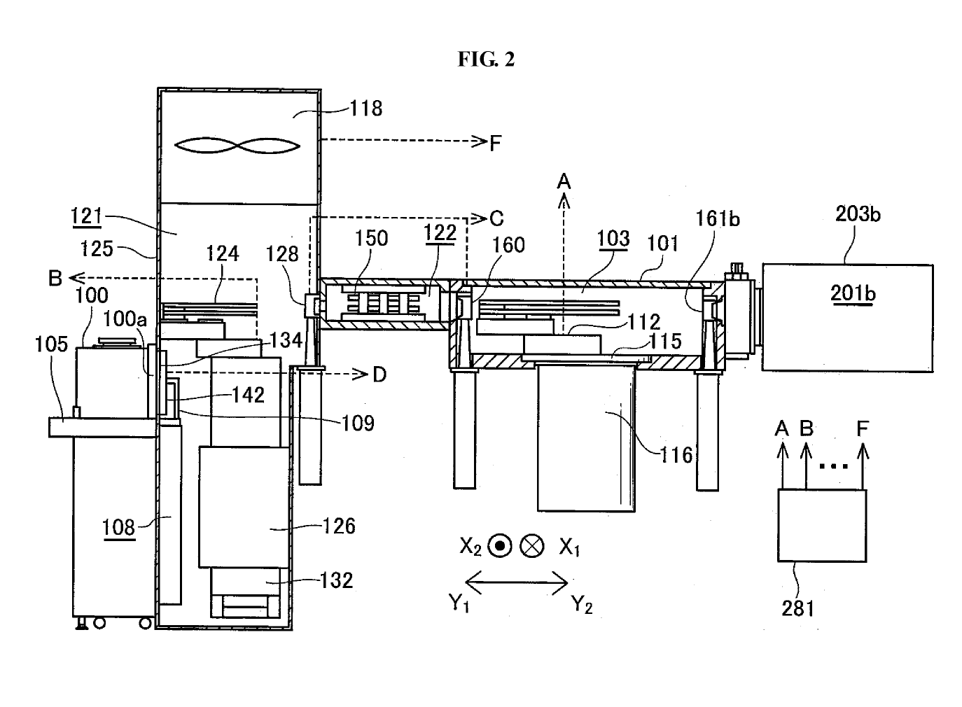

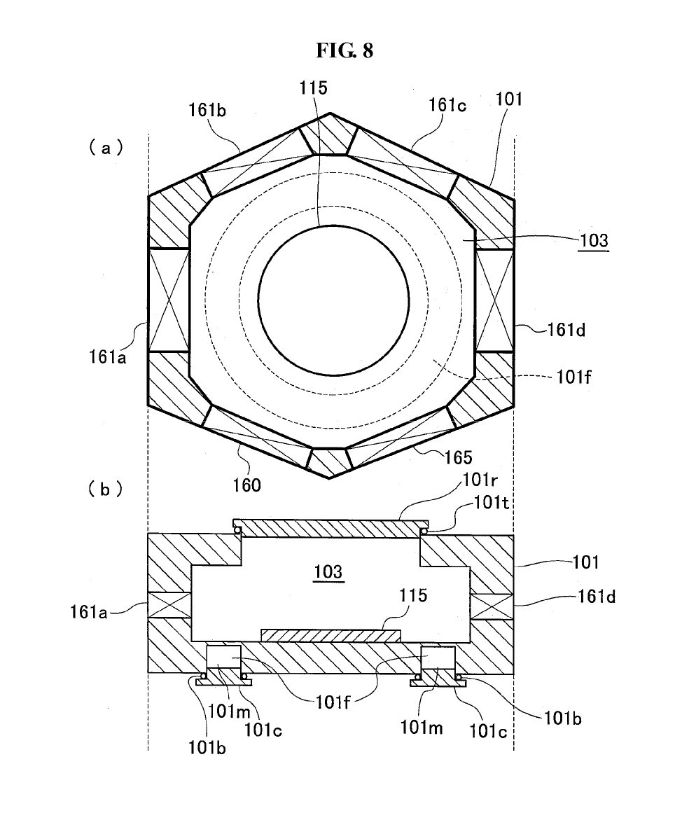

An overall configuration of the substrate processing apparatus according to one embodiment of the present invention will be described with reference to FIGS. 1, 2 and 8. FIG. 1 is a longitudinal cross-sectional view illustrating a configuration example of a substrate processing apparatus according to this embodiment. FIG. 2 is a vertical cross-sectional view illustrating a configuration example of the substrate processing apparatus according to this embodiment. FIG. 8 is a diagram illustrating a configuration example of a refrigerant channel provided with a vacuum transfer chamber according to this embodiment. Here, FIG. 8(a) is a longitudinal cross-sectional view of the vacuum transfer chamber, and FIG. 8(b) is a vertical cross-sectional view of the vacuum transfer chamber.

In FIGS. 1 and 2, in the substrate processing apparatus according to the present invention, a pod formed as a front opening unified pod (FOUP) is used as a carrier configured to transfer a substrate 200 such as a silicon (Si) substrate. A plurality of unprocessed or processed substrates 200 are configured to be stored respectively in a pod 100 in a horizontal posture. Also, in the following description, all front, rear, left and right sides are represented such that an X1 direction represents a right side, an X2 direction represents a left side, a Y1 direction represents a front side, and a Y2 direction represents a rear side.

(Vacuum Transfer Chamber)

As shown in FIGS. 1 and 2, the substrate processing apparatus includes a vacuum transfer chamber 103 (a transfer module) serving as a transfer chamber becoming a transfer space into which a substrate 200 is transferred under a negative pressure. A casing 101 constituting the vacuum transfer chamber 103 is formed in a hexagonal shape when viewed from a plane, and preparatory chambers 122 and 123 and process chambers 201a through 201d to be described later are connected to hexagonal sides via gate valves 160, 165 and 161a through 161d, respectively. A vacuum transfer robot 112 serving as a transfer robot configured to carry (transfer) the substrate 200 under a negative pressure is installed at a substantially central portion of the vacuum transfer chamber 103 using a flange 115 as a base.

As shown in FIG. 8(b), the casing 101 is formed in a box shape with its lower end closed and its upper end covered with a vacuum transfer chamber lid 101r via an O-ring 101t serving as an encapsulation member (a vacuum seal), and configured in a structure which can endure a pressure (negative pressure) less than an atmospheric pressure such as a vacuum condition. Also, walls such as side surfaces surrounding the vacuum transfer chamber 103 or top and bottom surfaces are, for example, made of aluminum. A surface of an inner wall of the vacuum transfer chamber 103 is, for example, subjected to anodic oxidation treatment of aluminum, known as alumite treatment. An aluminum-anodized film is formed, and the surface of the inner wall having a concavo-convex shape has a thermal absorptivity (corresponding to thermal emissivity) of, for example, 0.7 to 0.99, and serves as a heat-absorbing surface which may easily absorb heat.

Here, the thermal absorptivity indicates a value in which an energy content radiated from a surface of an object having a predetermined temperature is expressed at a ratio when an energy content radiated from a surface of a black body at the same temperature is set to 1.0. An object that may easily absorb heat may easily emit heat. According to Kirchhoff's law, the thermal absorptivity is identical to the thermal emissivity. In this application, a surface having high thermal absorptivity, that is, a surface that may easily absorb and emit heat, is referred to as a heat-absorbing surface or a heat-emitting surface, and a surface having low thermal absorptivity, that is, a surface that may not easily absorb heat but easily reflect the heat, is referred to as a heat-reflecting surface.

As described above, since substantially an entire wall of the vacuum transfer chamber 103 is, for example, made of an aluminum material, the vacuum transfer chamber 103 has an increased area to form an aluminum-anodized film. Therefore, the aluminum-anodized film may be, for example, formed over substantially an entire surface of the inner wall. Since the aluminum-anodized film has a surface formed in a concavo-convex shape therein, a vacuum suction efficiency may be lowered, or gas discharge (degassing) may occur in a chemical vapor deposition (CVD) process using an organic source, but resistance to a corrosive gas may, for example, be increased. Therefore, the aluminum-anodized film is preferably used in an etching process using the corrosive gas, and in also used substrate processing processes such as oxidation, nitridation, and acid nitridation.

Also, a refrigerant channel 101f through which a refrigerant such as cooling water flows is, for example, formed in the wall of the vacuum transfer chamber 103, and configured to be able to cool the inner wall of the vacuum transfer chamber 103. As shown in FIG. 8(a), the refrigerant channel 101f is installed in a bottom wall of the vacuum transfer chamber 103 to surround the base flange 115 of the vacuum transfer robot 112. At least one channel port 101m through which a refrigerant such as cooling water is injected or discharged is installed at an outer bottom wall of the vacuum transfer chamber 103. The channel port 101m is covered with a channel cover 101c via an O-ring 101b serving as an encapsulation member (a refrigerant seal). Also, when cooling water is used as the refrigerant, an inner wall of the refrigerant channel 101f is preferably treated with alumite so as to suppress corrosion, for example, electrochemical corrosion, of an inside of the refrigerant channel 101f.

Also, a chiller unit (not shown) and the like are connected to the refrigerant channel 101f to control a temperature of a liquid and circulate the cooling water. Therefore, the inner wall of the vacuum transfer chamber 103 may be cooled while the cooling water is circulated in the chiller unit in a state where the cooling water is maintained at a substantially constant temperature.

In general, a cooling unit according to this embodiment includes the refrigerant channel 101f, the channel port 101m, the channel cover 101c, the O-ring 101b and the chiller unit.

As described above, as high throughput of the substrate processing apparatus is made, the heat-treated substrate 200 may be transferred into the vacuum transfer chamber 103 in a state where the heat-treated substrate 200 is maintained at a high temperature. Even in this circumstance, the inner wall of the vacuum transfer chamber 103 treated with alumite and having high thermal absorptivity absorbs radiant heat from the substrate 200, so that the radiant heat received by the vacuum transfer robot 112 may be lowered.

Also, since the absorbed heat may be, for example, removed by circulating cooling water in the refrigerant channel 101f, an increase in temperature of the inner wall of the vacuum transfer chamber 103 may be suppressed. Since substantially an entire wall of the vacuum transfer chamber 103 is, for example, made of an aluminum material having high thermal conductivity, the vacuum transfer chamber 103 has high cooling efficiency. Accordingly, when the inner wall of the vacuum transfer chamber 103 is in a high-temperature state, heat may be prevented from being inversely emitted to the substrate 200 or the vacuum transfer robot 112. Also, when the inner wall of the vacuum transfer chamber 103 is excessively increased in temperature, the alumite may be peeled off due to a difference in thermal expansion between the alumite and a parent aluminum material. Such peeling of the alumite may be suppressed by cooling the inner wall of the vacuum transfer chamber 103.

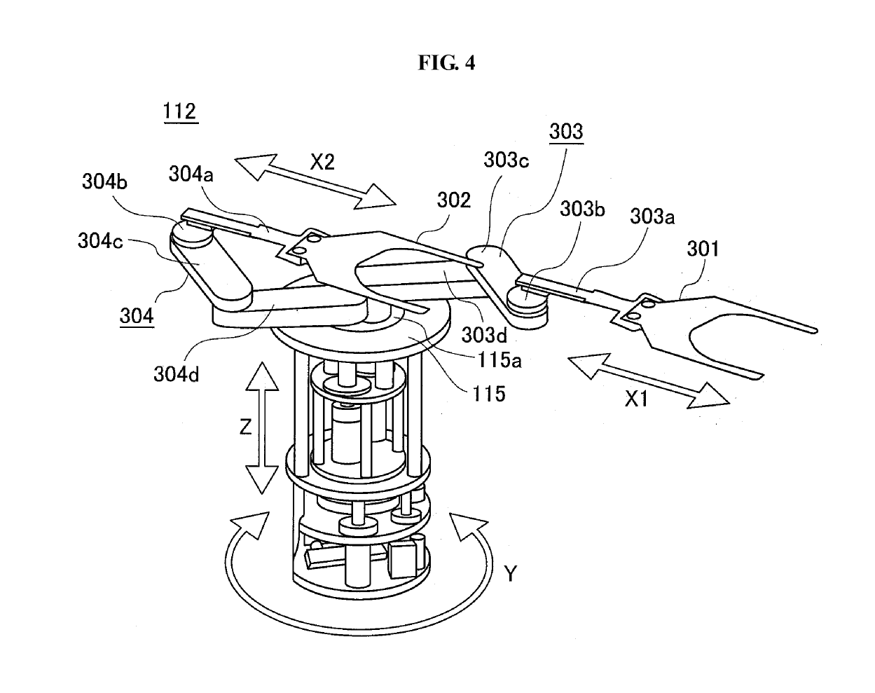

In addition, arms 303 and 304 (see FIG. 4) having the vacuum transfer robot 112, as will be described later, vertically operate with respect to a bottom surface of the vacuum transfer chamber 103. In this case, since the refrigerant channel 101f is installed at least at the bottom surface of the vacuum transfer chamber 103, an influence of the radiant heat on the arms 303 and 304 may be effectively lowered.

The vacuum transfer robot 112 installed in the vacuum transfer chamber 103 is configured to move up and down while maintaining airtightness of the vacuum transfer chamber 103 using an elevator 116 and the flange 115, as shown in FIG. 2. A detailed configuration of the vacuum transfer robot 112 will be described below.

(Preparatory Chamber)

The preparatory chamber 122 (a load lock module) for loading and the preparatory chamber 123 (a load lock module) for unloading are coupled to two sidewalls, which are positioned in front of the six sidewalls of the casing 101, via the gate valves 160 and 165, respectively, and configured in a structure which can endure a negative pressure.

Further, the substrate placing stage 150 for loading is installed in the preparatory chamber 122, and the substrate placing stage 151 for unloading is installed in the preparatory chamber 123.

(Atmospheric Transfer Chamber/IO Stage)

An atmospheric transfer chamber 121 (a front end module) is coupled to front sides of the preparatory chamber 122 and the preparatory chamber 123 via gate valves 128 and 129. The atmospheric transfer chamber 121 is used under a substantially atmospheric pressure.

An atmospheric transfer robot 124 configured to carry the substrate 200 is installed in the atmospheric transfer chamber 121. As shown in FIG. 2, the atmospheric transfer robot 124 is configured to move up and down by means of an elevator 126 installed at the atmospheric transfer chamber 121, and also configured to reciprocate in a horizontal direction by means of a linear actuator 132.

As shown in FIG. 2, a cleaning unit 118 configured to supply clean air is installed above the atmospheric transfer chamber 121. As shown in FIG. 1, a device 106 (hereinafter referred to as a “pre-aligner”) configured to adjust a notch or orientation flat formed as the substrate 200 is also installed at a left side of the atmospheric transfer chamber 121.

As shown in FIGS. 1 and 2, a substrate loading/unloading port 134 configured to load and unload the substrate 200 with respect to the atmospheric transfer chamber 121, and a pod opener 108 are installed in front of the casing 125 of the atmospheric transfer chamber 121. An 10 stage 105 (a load port) is installed opposite to the pod opener 108 with respect to the substrate loading/unloading port 134, that is, installed outside the casing 125.

The pod opener 108 includes a closure 142 capable of opening/closing a cap 100a of the pod 100 and simultaneously closing the substrate loading/unloading port 134, and a drive mechanism 109 configured to drive the closure 142. The pod opener 108 opens/closes the cap 100a of the pod 100 placed on the IO stage 105, and charges/discharges the substrate 200 with respect to the pod 100 by opening and closing a substrate entrance. The pod 100 is supplied and discharged with respect to the IO stage 105 by means of an in-process transfer device (RGV, not shown).

(Process Chamber)

As shown in FIG. 1, a second process chamber 201b (a process module) and a third process chamber 201c (a process module), both of which are configured to perform a desired treatment on the substrate 200, are adjacent and coupled to two sidewalls, which are positioned at a central rear side (back side) of the six sidewalls of the casing 101, via gate valves 161b and 161c, respectively. Both the second process chamber 201b and the third process chamber 201c are composed of cold-wall process containers 203b and 203c.

A first process chamber 201a (a process module) and a fourth process chamber 201d (a process module) are coupled to the other two opposite sidewalls among the six sidewalls of the casing 101 via gate valves 161a and 161d, respectively. Both the first process chamber 201a and the fourth process chamber 201d are also composed of cold-wall process containers 203a and 203d. The respective process chambers 201a through 201d will be described in detail below.

(Control Unit)

As shown in FIGS. 1 and 2, a controller 281 serving as a control unit is, for example, electrically connected to the vacuum transfer robot 112 through a signal line A, to the atmospheric transfer robot 124 through a signal line B, to the gate valves 160, 161a, 161b, 161c, 161d, 165, 128 and 129 through a signal line C, to the pod opener 108 through a signal line D, to the pre-aligner 106 through a signal line E, and to the cleaning unit 118 through a signal line F, so that the controller 281 controls operations of these parts constituting the substrate processing apparatus.

### (2) Configuration of Process Chamber

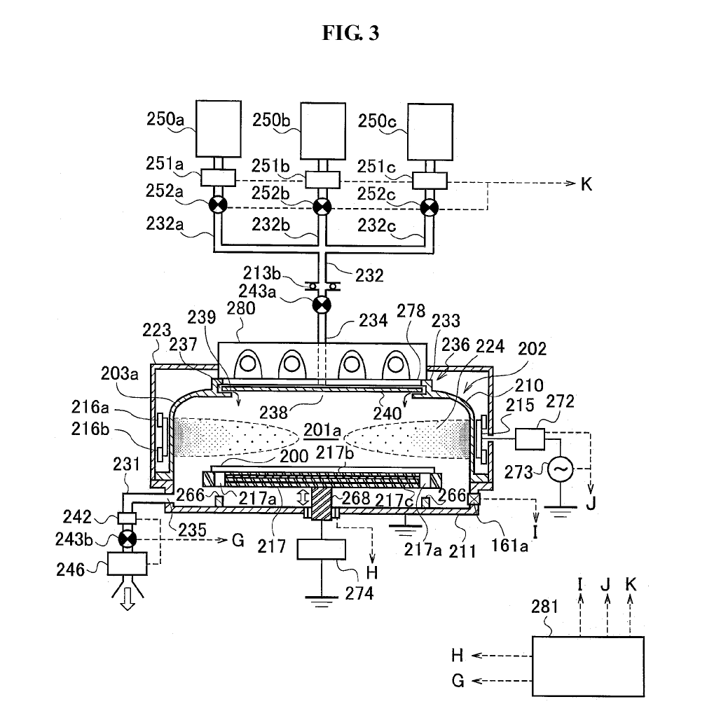

Next, a configuration and operation of the process chamber 201a according to one embodiment of the present invention will be described with reference to FIG. 3.

FIG. 3 is a cross-sectional view of an MMT device including a process chamber 201a among process chambers 201a through 201d, each of which has the same configuration. The MMT device is configured to process the substrate 200 such as, for example, a silicon substrate using a modified magnetron typed plasma source from which high-density plasma is generated by means of an electric field and a magnetic field. Hereinafter, a configuration example of the process chamber 201a and surroundings thereof will be described, but the other process chambers 201b through 201d may have the same configuration.

The MMT device includes a process furnace 202 configured to plasma-process the substrate 200. Also, the process furnace 202 includes a process container 203a constituting the process chamber 201a, a susceptor 217, a gate valve 161a, a shower head 236, a gas exhaust port 235, a first electrode 215 serving as a cylindrical electrode, an upper magnet 216a, a lower magnet 216b and a controller 281.

(Process Chamber)

The process container 203a constituting the process chamber 201a includes a dome-like upper container 210 serving as a first container and a bowl-shaped lower container 211 serving as a second container. Then, the process chamber 201a is formed by covering the lower container 211 with the upper container 210. The upper container 210 is, for example, made of a non-metallic material such as aluminum oxide (Al₂O₃) or quartz (SiO₂), and the lower container 211 is, for example, made of aluminum (Al).

The gate valve 161a serving as an opening/closing valve is installed at a sidewall of the lower container 211. When the gate valve 161a is kept open, the substrate 200 may be loaded into the process chamber 201a using the above-described vacuum transfer robot 112, or the substrate 200 may be unloaded from the process chamber 201a. An inside of the process chamber 201a may be airtightly closed by closing the gate valve 161a.

(Substrate Support)

The susceptor 217 serving as a substrate placing stage configured to support the substrate 200 is arranged at a lower center of an inside of the process chamber 201a. The susceptor 217 is, for example, made of a non-metallic material such as aluminum nitride (AlN), ceramic or quartz to reduce metal contamination in a film formed on the substrate 200.

A resistance heater 217b serving as a heating mechanism may be integrally buried in the susceptor 217 to heat the substrate 200. When electric power is supplied to the resistance heater 217b, a surface of the substrate 200, for example, is at room temperature or higher, and may be preferably heated to approximately 200° C. to 700° C., or approximately 750° C.

The susceptor 217 is electrically insulated from the lower container 211. An inside of the susceptor 217 is equipped with a second electrode 217c serving as an electrode configured to change impedance. The second electrode 217c is earthed via an impedance variable mechanism 274. The impedance variable mechanism 274 includes a coil or a variable condenser. Electric potential of the substrate 200 may be controlled via the second electrode 217c and the susceptor 217 by controlling a pattern number of the coil or a capacity value of the variable condenser.

A susceptor elevating mechanism 268 configured to elevate the susceptor 217 is installed at the susceptor 217. A through-hole 217a is installed at the susceptor 217. At least three substrate elevation pins 266 configured to elevate the substrate 200 are installed at a bottom surface of the above-described lower container 211. Then, the through-hole 217a and the substrate elevation pins 266 are arranged so that the substrate elevation pin 266 can pass through the through-hole 217a with no contact with the susceptor 217 when the susceptor 217 moves down by the susceptor elevating mechanism 268.

In general, a substrate support according to this embodiment is composed of the susceptor 217 and the resistance heater 217b.

(Lamp Heating Device)

A light-transmissible window 278 is disposed at an upper surface of the process container 203a. A lamp heating device 280 (a lamp heater) serving as a substrate heater which is a light source that emits infrared light is installed outside the process container 203a corresponding to the light-transmissible window 278. The lamp heating device 280 is configured to be able to heat the substrate 200 to a temperature greater than 700° C. In the case of the above-described resistance heater 217b whose upper limit temperature is, for example, set to approximately 700° C., the lamp heating device 280 is used as an auxiliary heater when the substrate 200 is heat-treated at a temperature greater than 700° C.

(Gas Supply Unit)

The shower head 236 configured to supply a process gas such as a reactive gas into the process chamber 201a is installed above the process chamber 201a. The shower head 236 includes a cap-shaped lid 233, a gas introduction port 234, a buffer chamber 237, an opening 238, a shielding plate 240 (a shower plate) and a gas discharge port 239.

A downstream end of the gas supply pipe 232 configured to supply the process gas into the buffer chamber 237 is connected to the gas introduction port 234 via an O-ring 213b serving as an encapsulation member and a valve 243a serving as an opening/closing valve. The buffer chamber 237 functions as a dispersion space configured to disperse a gas introduced through the gas introduction port 234.

A downstream end of a nitrogen gas supply pipe 232a configured to supply nitrogen (N₂) gas as a nitrogen atom-containing gas, a downstream end of a hydrogen gas supply pipe 232b configured to supply hydrogen (H₂) gas as a hydrogen atom-containing gas, and a downstream end of a rare gas supply pipe 232c configured to supply a rare gas as a dilute gas such as, for example, helium (He) gas or argon (Ar) gas are connected to an upstream side of the gas supply pipe 232 so that the nitrogen gas supply pipe 232a, the hydrogen gas supply pipe 232b and the rare gas supply pipe 232c can join the gas supply pipe 232.

A nitrogen gas cylinder 250a, a mass flow controller 251a serving as a flow rate control device and a valve 252a serving as an opening/closing valve are connected to the nitrogen gas supply pipe 232a in a sequential order from an upstream side thereof. A hydrogen gas cylinder 250b, a mass flow controller 251b serving as a flow rate control device and a valve 252b serving as an opening/closing valve are connected to the hydrogen gas supply pipe 232b in a sequential order from an upstream side thereof. A rare gas cylinder 250c, a mass flow controller 251c serving as a flow rate control device and a valve 252c serving as an opening/closing valve are connected to the rare gas supply pipe 232c in a sequential order from an upstream side thereof.

The gas supply pipe 232, the nitrogen gas supply pipe 232a, the hydrogen gas supply pipe 232b and the rare gas supply pipe 232c are, for example, made of a non-metallic material such as quartz or aluminum oxide and a metal material such as stainless steel (SUS). A flow rate is controlled by the mass flow controllers 251a through 251c by opening/closing the valves 252a through 252c installed in each gas supply pipe, and thus the gas supply pipes are configured to be able to freely supply N₂ gas, H₂ gas and a rare gas into the process chamber 201a via the buffer chamber 237.

In general, a gas supply unit according to this embodiment includes the gas supply pipe 232, the nitrogen gas supply pipe 232a, the hydrogen gas supply pipe 232b, the rare gas supply pipe 232c, the nitrogen gas cylinder 250a, the hydrogen gas cylinder 250b, the rare gas cylinder 250c, the mass flow controllers 251a through 251c and the valves 252a through 252c.

Here, an example where a gas cylinder for N₂ gas, H₂ gas or a rare gas is provided has been described, but the present invention is not limited to such an embodiment. An oxygen (O₂) gas cylinder may be installed instead of the nitrogen gas cylinder 250a and the hydrogen gas cylinder 250b. Also, when a ratio of nitrogen in a reactive gas supplied into the process chamber 201a is high, an ammonia (NH₃) gas cylinder may be further installed, and NH₃ gas may be added to N₂ gas.

(Gas Exhaust Unit)

The gas exhaust port 235 configured to exhaust a reactive gas from the process chamber 201a is installed at a lower portion of a sidewall of the lower container 211. An upstream end of a gas exhaust pipe 231 configured to exhaust a gas is connected to the gas exhaust port 235. An automatic pressure controller (APC) 242 serving as a pressure aligner, a valve 243b serving as an opening/closing valve and a vacuum pump 246 serving as an exhaust device are installed at the gas exhaust pipe 231 in a sequential order from an upstream side thereof. An inside of the process chamber 201a may be exhausted by operating the vacuum pump 246 and opening the valve 243b. Also, a pressure valve in the process chamber 201a may be adjusted by adjusting an opening angle of the APC 242.

In general, a gas exhaust unit according to this embodiment includes the gas exhaust port 235, the gas exhaust pipe 231, the APC 242, the valve 243b and the vacuum pump 246.

(Plasma Generating Unit)

The first electrode 215 is installed at a circumference of the process container 203a (the upper container 210) to surround a plasma generating region 224 in the process chamber 201a. The first electrode 215 is formed in a tube-like shape, for example, a cylindrical shape. The first electrode 215 is connected to a high-frequency power source 273 configured to generate high-frequency power via an aligner 272 configured to perform alignment of impedance. The first electrode 215 functions as a discharge mechanism configured to excite a gas supplied into the process chamber 201a so as to generate plasma.

An upper magnet 216a and a lower magnet 216b are installed at upper/lower end portions of an outer surface of the first electrode 215, respectively. Each of the upper magnet 216a and the lower magnet 216b is configured as a permanent magnet formed in a tube-like shape, for example, a ring-like shape.

Each of the upper magnet 216a and the lower magnet 216b has magnetic poles formed respectively at both ends (that is, inner and outer circumferential ends of a magnet) thereof in a radial direction of the process chamber 201a. The upper magnet 216a and the lower magnet 216b are arranged so that the magnetic poles of the upper magnet 216a and the lower magnet 216b can be formed in an opposite direction. That is, the inner circumferential portions of the upper magnet 216a and the lower magnet 216b have different magnetic poles. Accordingly, magnetic lines are formed along an inner surface of the first electrode 215 in a cylindrical axial direction.

When a magnetic field is formed using the upper magnet 216a and the lower magnet 216b, and an electric field is also formed by introducing a mixed gas of, for example, N₂ gas and H₂ gas into the process chamber 201a and supplying high-frequency power to the first electrode 215, magnetron discharge plasma is generated in the process chamber 201a. In this case, since emitted electrons are circulated by the above-described electromagnetic field, a plasma ionization rate may be improved and high-density plasma having a long lifespan may be generated.

In general, a plasma generating unit according to this embodiment includes the first electrode 215, the aligner 272, the high-frequency power source 273, the upper magnet 216a and the lower magnet 216b.

In addition, a metallic shielding plate 223 configured to effectively shield an electromagnetic field is installed around the first electrode 215, the upper magnet 216a and the lower magnet 216b so that the electromagnetic field which is formed by the first electrode 215, the upper magnet 216a and the lower magnet 216b can adversely affect outer environments or other devices such as a process furnace.

(Control Unit)

Further, the controller 281 serving as a control unit is electrically connected to the APC 242, the valve 243b and the vacuum pump 246 through a signal line G, to the susceptor elevating mechanism 268 through a signal line H, to the gate valve 161a through a signal line I, to the aligner 272 and the high-frequency power source 273 through a signal line J, to the mass flow controllers 251a through 251c and the valves 252a through 252c through a signal line K, and to the resistance heater 217b buried in the susceptor 217 and the impedance variable mechanism 274 through a signal line (not shown), so that the controller 281 controls these parts, respectively.

### (3) Configuration of Vacuum Transfer Robot

Next, a configuration and operation of the vacuum transfer robot 112 according to one embodiment of the present invention will be described with reference to FIGS. 1, 2 and 4. FIG. 4 is a diagram illustrating a configuration example of the vacuum transfer robot 112 according to this embodiment.

As shown in FIG. 4, the vacuum transfer robot 112 includes a pair of arms 303 and 304 configured to temporarily hold (support) and transfer the substrate 200. The arm 303 is composed of an end effector fixing arm 303a, an arm joint 303b, an end effector side arm 303c and a flange side arm 303d. The arm 304 is composed of an end effector fixing arm 304a, an arm joint 304b, an end effector side arm 304c and a flange side arm 304d.

Ceramic end effectors 301 and 302 configured to support the substrate 200 in a horizontal posture are installed at front ends of the arms 303 and 304, respectively. Also, each of the arms 303 and 304 may be configured to horizontally move in horizontal directions (X1 and X2 directions in the drawings), rotationally move in a Y direction in the drawings, and vertically move in a Z direction in the drawings.

The arms 303 and 304 are, for example, made of aluminum. At least some surfaces of the arms 303 and 304 are, for example, subjected to electropolishing, so that the surfaces of the arms 303 and 304 have a thermal absorptivity (corresponding to thermal emissivity) of, for example, 0.01 to 0.1. When the thermal absorptivity is set to 0.01 to 0.1, the surfaces of the arms 303 and 304 are formed as a heat-reflecting surface which easily reflects heat so that the arms 303 and 304 cannot easily absorb heat (electromagnetic waves).

Therefore, temperatures of the arms 303 and 304 are not easily increased. This is explained from the following equation. As shown in the following equation, the higher thermal emissivity (thermal absorptivity) of a side receiving thermal radiation (here, the arms 303 and 304) is, the lower a capacity of heat emitted to a side emitting heat from an object (here, the substrate 200) is.

q=σ/{1/ε₂+A₂/A₁·(1/ε₁−1)}·A₂(T₂⁴−T₁⁴)

### q: Capacity of Emitted Heat, σ: Stefan-Boltzmann's Constant

A1: Surface Area of Arm, T1: Temperature of Arm, E1: Thermal Emissivity of Arm

A2: Surface Area of Substrate, T2: Temperature of Substrate, E2: Thermal Emissivity of Substrate

The electro-polished heat-reflecting surface may, for example, include at least one or both of the upper surfaces of the arms 303 and 304 configured to support the substrate 200 and the surfaces of the arms 303 and 304 that are easily susceptible to thermal radiation from an inside of each of the process chambers 201a through 201d. The surfaces that are easily susceptible to thermal radiation from an inside of each of the process chambers 201a through 201d refer to surfaces disposed in positions where the arms 303 and 304 are directed toward a side of each of the process chambers 201a through 201d, for example, where the inside of each of the process chambers 201a through 201d can be viewed from openings of the gate valves 161a through 161d. Also, surfaces of the end effector fixing arms 303a and 304a and the arm joints 303b and 304b may be heat-reflecting surfaces, and substantially the entire surfaces of the arms 303 and 304 may be heat-reflecting surfaces.

When a surface that is susceptible to thermal radiation from the substrate 200 or the inside of each of the process chambers 201a through 201d is formed as the heat-reflecting surface as described above, an increase in temperature of the arms 303 and 304 may be effectively suppressed. Also, when the surface of the inner wall of the vacuum transfer chamber 103 is, for example, formed as the alumite-treated heat-absorbing surface, and the surfaces of the arms 303 and 304 are, for example, formed as the electro-polished heat-reflecting surface, as described above, the thermal absorptivity of the surfaces of the arms 303 and 304 may be relatively lowered, compared to the thermal absorptivity of the surface of the inner wall of the vacuum transfer chamber 103. Therefore, radiant heat from the substrate 200 may be absorbed into the inner wall of the vacuum transfer chamber 103 rather than the arms 303 and 304. As a result, an increase in temperature of the arms 303 and 304 may be further effectively suppressed.

As such, when the increase in temperature of the arms 303 and 304 is suppressed, the arms 303 and 304 expand to suppress deviation of a transfer position and generation of transfer errors. Also, a motor, a magnetic seal, grease and a timing belt installed around the arms 303 and 304 may be protected, and degradation of lifespan and reliability of the vacuum transfer robot 112 may be suppressed.

Also, the vacuum transfer robot 112 is fixed in the vacuum transfer chamber 103 by means of the flange 115. The flange 115 is, for example, formed of aluminum. A flange surface 115a is, for example, subjected to electropolishing, and thermal absorptivity of the flange surface 115a is in a range of 0.01 to 0.1. When the thermal absorptivity of the flange surface 115a is set to 0.01 to 0.1, the flange surface 115a is formed as a heat-reflecting surface which cannot easily absorb heat (electromagnetic waves) but easily reflects the heat. Therefore, a temperature of the flange 115 is not easily increased. When an increase in temperature of the flange 115 is suppressed, a motor, a magnetic seal, grease and a timing belt installed around the arms 303 and 304 may be protected, and degradation of lifespan and reliability of the vacuum transfer robot 112 may be suppressed.

In addition, the arm 303 installed in the vacuum transfer robot 112 may be used as an exclusive arm configured to transfer only the non-processed substrate 200, and the arm 304 may be used as an exclusive arm configured to transfer only the processed substrate 200. When the arms 303 and 304 are used as the exclusive arms, respectively, attachment of particulates to the non-processed substrate 200 may be suppressed even when the particulates are formed from the processed substrate 200. Also, even when the particulates are formed from the processed substrate 200, the attachment of the particulates to the processed substrate 200 may be suppressed. That is, contamination from the processed substrate 200 to the non-processed substrate 200 and contamination from the non-processed substrate 200 to the processed substrate 200 may be suppressed. That is, the present invention is not limited to the above-described embodiment, and any one of the arms 303 and 304 which may transfer the non-processed substrate 200 and the processed substrate 200 may also be used as non-exclusive arms.

As described above, when the arms 303 and 304 are used as the exclusive arms, respectively, only a surface of the arm 304 configured to transfer the heated processed substrate 200 may be electro-polished.

### (4) Substrate Processing Process

Hereinafter, as one process of the method of manufacturing a semiconductor device, a process of processing the substrate 200, particularly a heating process using plasma, will be described with reference to FIGS. 1 through 3 using the substrate processing apparatus having the above-described configuration. Also, in the following description, operations of respective parts constituting the substrate processing apparatus are controlled by the controller 281.

(Transfer Process from Side of Atmospheric Transfer Chamber)

For example, the 25 non-processed substrates 200 are transferred to the substrate processing apparatus configured to perform a heating process by means of an in-process transfer device in a state where the non-processed substrates 200 are accommodated in the pod 100. As shown in FIGS. 1 and 2, the transferred pod 100 is received from the in-process transfer device, and placed on the TO stage 105. The cap 100a of the pod 100 is separated by the pod opener 108, and a substrate entrance of the pod 100 is opened.

When the pod 100 is opened by the pod opener 108, the atmospheric transfer robot 124 installed at the atmospheric transfer chamber 121 picks up the substrate 200 from the pod 100, loads the substrate 200 into the preparatory chamber 122, and carries the substrate 200 onto the substrate placing stage 150. During this carrying operation, a gate valve 160 of the preparatory chamber 122 disposed in a side of the vacuum transfer chamber 103 is closed, and a negative pressure in the vacuum transfer chamber 103 is maintained.

When carrying a predetermined number of the substrates 200 (for example, 25 substrates 200) accommodated in the pod 100 to the substrate placing stage 150 is completed, the gate valve 128 is closed, and an inside of the preparatory chamber 122 is exhausted at a negative pressure by means of an exhaust device (not shown).

When the inside of the preparatory chamber 122 reaches a previously set pressure value, the gate valve 160 is opened, and the preparatory chamber 122 communicates with the vacuum transfer chamber 103.

Subsequently, by using the functions of the above-described horizontal movement, rotary movement and vertical movement, the vacuum transfer robot 112 loads the substrate 200 from the inside of the preparatory chamber 122 to an inside of the vacuum transfer chamber 103. More particularly, the substrate 200 is picked up from the substrate placing stage 150 in the preparatory chamber 122 and loaded into the vacuum transfer chamber 103, for example, by means of the arm 303 configured to transfer the non-processed substrate 200 among the arms 303 and 304 provided in the vacuum transfer robot 112. After the substrate 200 is loaded into the vacuum transfer chamber 103 and the gate valve 160 is closed, for example, the gate valve 161a is opened, and the first process chamber 201a communicates with the vacuum transfer chamber 103.

Hereinafter, operations of loading the substrate 200 into the first process chamber 201a, processing the substrate 200 (including heat treatment), and unloading the substrate 200 from an inside of the first process chamber 201a will be described with reference to FIG. 3 in which the process chamber 201a is provided.

(Loading Process)

First, the vacuum transfer robot 112 loads the substrate 200 from an inside of the vacuum transfer chamber 103 into the first process chamber 201a, and carries the substrate 200 on the susceptor 217 in the first process chamber 201a. More particularly, first, the susceptor 217 moves down, and a front end of the substrate elevation pin 266 protrudes through the through-hole 217a of the susceptor 217 up to a predetermined height from a surface of the susceptor 217. In this circumstance, the gate valve 161a installed in the lower container 211 is opened, as described above. Next, the substrate 200 supported by the arm 303 is placed in the front end of the substrate elevation pin 266 by means of the arm 303 of the vacuum transfer robot 112. Thereafter, the arm 303 is retrieved from the process chamber 201a. Then, the gate valve 161a is closed, and the susceptor 217 is elevated by the susceptor elevating mechanism 268. As a result, the substrate 200 is placed on a surface of the susceptor 217. The substrate 200 placed on the susceptor 217 is elevated to a position where the substrate 200 is further processed.

After the gate valve 161a is closed as described above, substrate processing (including desired heat treatment) in the first process chamber 201a is performed according to the following sequential order.

(Heating/Pressure Adjusting Process)

The resistance heater 217b buried in the susceptor 217 is pre-heated. The substrate 200 is, for example, heated from room temperature to a substrate processing temperature of approximately 700° C. using the resistance heater 217b. A pressure in the process chamber 201a is, for example, maintained in a range of 0.1 Pa to 300 Pa using the vacuum pump 246 and the APC valve 242.

In addition, in the process furnace 202 having the above-described configuration, a temperature of the substrate 200 which may be heated by the resistance heater 217b buried in the susceptor 217 as described above is at most 700° C. Therefore, substrate processing requiring a processing temperature greater than 700° C. may not be performed using only the resistance heater 217b.

For this purpose, in order to enable the substrate processing requiring the processing temperature greater than 700° C., as described above, a lamp heating device 280 (a lamp heater) serving as a substrate heater that is a light source configured to emit infrared light is further provided in addition to the resistance heater 217b. In the heating/pressure adjusting process, such a lamp heating device 280 is used as an auxiliary heater to heat the substrate 200 to a substrate processing temperature greater than 700° C., when necessary.

(Heating Process)

After the substrate 200 is heated to the substrate processing temperature, the following substrate processing (including desired heat treatment) is performed while the substrate 200 is maintained at a predetermined temperature. That is, a process gas is supplied in a shower shape from the gas introduction port 234 toward a surface (a process surface) of the substrate 200 arranged in the process chamber 201a via the opening 238 of the shower plate 240, depending on a desired process such as oxidation, nitridation, film formation or etching. At the same time, high-frequency power is supplied from the high-frequency power source 273 to the first electrode 215 via the aligner 272. The supplied electric power is, for example, in a range of 100 W to 1000 W, for example, 800 W. Also, the impedance variable mechanism 274 is previously set to a desired impedance value.

A magnetron discharge is generated by magnetic fields of the tube-like upper/lower magnets 216a and 216b, and electric charges are captured in an upper space of the substrate 200 to generate high-density plasma at the plasma generating region 224. Due to the presence of the high-density plasma, an oxide or nitride film or a thin film is formed on the surface of the substrate 200 placed on the susceptor 217, or plasma processing such as etching is performed.

Also, the controller 281 controls a power ON/OFF state of the high-frequency power source 273, adjustment of the aligner 272, opening/closing of the valves 252a through 252c and 243a, flow rates of the mass flow controllers 251a through 251c, a valve opening angle of the APC valve 242, opening/closing of the valve 243b, drive and stop of the vacuum pump 246, an elevating operation of the susceptor elevating mechanism 268, opening/closing of the gate valve 161a, and an ON/OFF state of the high-frequency power source configured to supply electric power such as high frequency to the resistance heater 217b buried in the susceptor 217.

(Unloading Process)

When cooling of the substrate 200 by a transfer means is not finished, that is, while the substrate 200 is maintained at a temperature relatively close to the substrate processing temperature, the substrate 200 processed in the first process chamber 201a is transferred out of the first process chamber 201a through a reverse operation of loading the substrate 200. That is, when the substrate processing of the substrate 200 is completed, the gate valve 161a is opened. Also, the susceptor 217 is lowered to a position where the substrate 200 is transferred, and the substrate 200 may be elevated by allowing the front end of the substrate elevation pin 266 to protrude from the through-hole 217a of the susceptor 217. The processed substrate 200 is, for example, unloaded into the vacuum transfer chamber 103 by means of the arm 304 provided in the vacuum transfer robot 112 to transfer the processed substrate 200. After the unloading process, the gate valve 161a is closed.

In addition, in at least the unloading process, the chiller unit connected to the refrigerant channel 101f of the vacuum transfer chamber 103 is operated to transfer the substrate 200 while temperature-controlled cooling water is circulated in the refrigerant channel 101f. Therefore, a cooling effect of the inner wall of the vacuum transfer chamber 103 may be enhanced, and an increase in temperature of the inner wall or the arms 303 and 304 may be suppressed. The cooling process using the refrigerant channel 101f continues to be performed until the unloading process is completed starting from the loading process, or until all the substrates 200 are transferred to the pod 100 after the pod 100 is placed on the IO stage 105 of the substrate processing apparatus, as will be described later.

The above-described operations of loading the substrate 200 into the first process chamber 201a, processing the substrate 200 (including heat treatment), and unloading the substrate 200 from an inside of the first process chamber 201a are completed.

The vacuum transfer robot 112 transfers the processed substrate 200 unloaded from the first process chamber 201a into the preparatory chamber 123. After the substrate 200 is carried on the substrate placing stage 151 in the preparatory chamber 123, the preparatory chamber 123 is closed by the gate valve 165.

A predetermined number of the substrates 200 (for example, 25 substrates 200) loaded into the preparatory chamber 122 are sequentially processed by repeating the above-described operations.

After the heat treatment in the process chamber 201a is performed, the thermal absorptivity of the surfaces of the arms 303 and 304 of the vacuum transfer robot 112 is in a range of 0.01 to 0.1 even when the high-temperature substrate 200 is transferred into the vacuum transfer chamber 103. Therefore, an increase in temperature of the vacuum transfer robot 112 may be suppressed, and thus a motor, a magnetic seal, grease and a timing belt installed at the vacuum transfer robot 112 may be protected, and degradation of lifespan and reliability of the vacuum transfer robot 112 may be suppressed.

In addition, the surface of the inner wall of the vacuum transfer chamber 103 is treated with alumite so that the surface of the inner wall has a thermal absorptivity of 0.7 to 0.99, and has a structure which may be cooled using the refrigerant channel 101f. Therefore, the inner wall of the vacuum transfer chamber 103 may easily absorb a radiant heat from the substrate 200. Accordingly, the radiant heat which is not absorbed but reflected from the vacuum transfer robot 112 is absorbed into the inner wall of the vacuum transfer chamber 103, and thus the radiant heat cannot easily return to the vacuum transfer robot 112.

When the plurality of substrates 200 are continuously processed, the loading process and the unloading process with respect to the same process chamber (for example, the process chamber 201a) may also be performed at substantially the same time. That is, when the gate valve 161a is kept open, the processed substrate 200 in the process chamber 201a is picked up, for example, using the arm 304, and the arm 303 configured to support the non-processed substrate 200 is then introduced into the process chamber 201a to carry the non-processed substrate 200. Thereafter, the gate valve 161a is closed. As such, manufacturing throughput of the substrate processing apparatus may be improved by adjusting transfer timing for the process chamber 201a of each of the arms 303 and 304.

(Transfer Process to Side of Atmospheric Transfer Chamber)

When the substrate processing of all the substrates 200 loaded into the preparatory chamber 122 is completed, all the processed substrates 200 are accommodated in the preparatory chamber 123, and when the preparatory chamber 123 is closed by the gate valve 165, the inside of the preparatory chamber 123 returns to a substantially atmospheric pressure through the supply of an inert gas. When the inside of the preparatory chamber 123 returns to the substantially atmospheric pressure, the gate valve 129 is opened, and the cap 100a of the empty pod 100 placed on the IO stage 105 is opened by the pod opener 108.

Next, the atmospheric transfer robot 124 of the atmospheric transfer chamber 121 picks up the substrate 200 from the substrate placing stage 151 in the preparatory chamber 123, unloads the substrate 200 into the atmospheric transfer chamber 121, and accommodates the substrate 200 into the pod 100 through the substrate loading/unloading port 134 of the atmospheric transfer chamber 121. For example, when the accommodation of the 25 processed substrates 200 into the pod 100 is completed, the cap 100a of the pod 100 is closed by the pod opener 108. The closed pod 100 is transferred from the IO stage 105 for the next process using the in-process transfer device.

The above-described operations have been described as one case where the first process chamber 201a is used. However, even when the second process chamber 201b, the third process chamber 201c and the fourth process chamber 201d are used, the following operations are performed. Also, in the above-described substrate processing apparatus, the preparatory chamber 122 is used for loading of the substrates 200, and the preparatory chamber 123 is used for unloading of the substrates 200, but the preparatory chamber 123 may be used for loading of the substrates 200, and the preparatory chamber 122 may be used for unloading of the substrates 200.

Also, the same or different processes may be performed in the first process chamber 201a, the second process chamber 201b, the third process chamber 201c and the fourth process chamber 201d. When the different processes are performed in the first process chamber 201a, the second process chamber 201b, the third process chamber 201c and the fourth process chamber 201d, for example, the substrate 200 may be processed in the first process chamber 201a, and another processing may then be performed in the second process chamber 201b. After the substrate 200 is processed in the first process chamber 201a, another processing of the substrate 200 may also be performed in the second process chamber 201b, and additional processes may then be performed in the third process chamber 201c or the fourth process chamber 201d.

### (5) Effects According to this Embodiment

According to this embodiment, one or more effects as described later are obtained.

(a) According to this embodiment, the substrate processing apparatus includes a vacuum transfer chamber 103 having a substrate 200 transferred thereinto under a negative pressure, a process chamber 201a connected to the vacuum transfer chamber 103 and configured to heat the substrate 200, a vacuum transfer robot 112 installed in the vacuum transfer chamber 103 and configured to transfer the substrate 200 into and out of the process chamber 201a, and a refrigerant channel 101f installed in a wall of the vacuum transfer chamber 103 and configured to cool an inner wall of the vacuum transfer chamber 103. Therefore, after the heating of the substrate 200, a radiant heat transferred from the substrate 200 to the inner wall of the vacuum transfer chamber 103 may be emitted, and an increase in temperature of the inner wall may be suppressed, thereby suppressing thermal radiation from the inner wall to the vacuum transfer robot 112. Therefore, thermal absorption of each part of the vacuum transfer robot 112 may be lowered, a number of substrates processed per unit time may be increased, thereby improving manufacturing throughput of the substrate processing apparatus.

(b) Particularly, when the refrigerant channel 101f is configured to cool a bottom surface of the vacuum transfer chamber 103 which is at least opposite to the lower surfaces of the arms 303 and 304, an influence of radiant heat to be transferred from the bottom surface of the vacuum transfer chamber 103 to the arms 303 and 304 operating immediately above the bottom surface may be reduced.

(c) According to this embodiment, the surface of the inner wall of the vacuum transfer chamber 103 comprises a heat-absorbing surface having an aluminum-anodized film thereon. Also, the heat-absorbing surface of the vacuum transfer chamber 103 has a thermal absorptivity of 0.7 to 0.99. Therefore, a radiant heat from the heated substrate 200 may be easily absorbed by the inner wall of the vacuum transfer chamber 103. Accordingly, thermal absorption of the vacuum transfer robot 112 may be lowered, and an increase in temperature of the vacuum transfer robot 112 may be suppressed.

(d) In addition, according to this embodiment, the vacuum transfer robot 112 includes the arms 303 and 304 configured to support the substrate 200, and at least a portion of the surfaces of the arms 303 and 304 comprises electro-polished heat-reflecting surfaces. Also, the heat-reflecting surfaces of the arms 303 and 304 have a thermal absorptivity of 0.01 to 0.1. Therefore, since the radiant heat from the substrate 200 is not easily transmitted to the arms 303 and 304, an increase in temperatures of the arms 303 and 304 may be suppressed.

(e) Particularly, when the surfaces of the arms 303 and 304 which are heat-reflecting surfaces are formed as the upper surfaces of the arms 303 and 304 configured to support the substrate 200 and surfaces receiving thermal radiation from an inside of the process chamber 201, reflection of heat on a surface which is easily susceptible to thermal radiation may be improved, and an increase in temperatures of the arms 303 and 304 by the radiant heat may be suppressed.

(f) Also, according to this embodiment, a surface of the inner wall of the vacuum transfer chamber 103 is a heat-absorbing surface having an aluminum-anodized film thereon, and at least parts of the surfaces of the arms 303 and 304 are electro-polished heat-reflecting surfaces. Therefore, thermal absorption of the surfaces of the arms 303 and 304 may be relatively reduced with respect to the inner wall of the vacuum transfer chamber 103, and an increase in temperatures of the arms 303 and 304 may be suppressed.

### Other Embodiments of the Present Invention

Although the embodiments of present invention have been described in detail above, the present invention is not limited to the above-described embodiments, and various changes and modifications can be made without departing from the scope of the present invention.

For example, in the above-described embodiments, it is assumed that the refrigerant channel 101f is installed in a wall of the bottom surface of the vacuum transfer chamber 103, but the refrigerant channel may be installed in a wall of a side surface or an upper surface, or installed in the vacuum transfer chamber lid 101r. In addition to the cooling water, various liquids such as an organic solvent or various gases such as dry air and an inert gas may be used as the refrigerant.

Also, in the above-described embodiments, it is assumed that the cooling unit provided with the vacuum transfer chamber 103 is composed of the refrigerant channel 101f, but the cooling unit may have different configurations in addition to or in substitution of the refrigerant channel 101f. For example, the cooling unit may be a heat exchanger installed at an outer wall of the vacuum transfer chamber. For example, a block-shaped member, a heat sink or a heat pipe, which has a refrigerant channel formed therein, may be used as the heat exchanger. The block-shaped member may be installed in the vacuum transfer chamber. In addition, the cooling unit may be an air blower configured to blow a gas such as dry air to the outer wall of the vacuum transfer chamber from an outside.

Also, in the above-described embodiments, the use of the substrate processing apparatus in which the inner wall of the vacuum transfer chamber 103 is treated with alumite has been described, but the present invention is not limited to such embodiments. The vacuum transfer chamber may be formed of a material having strength substantially identical to or higher than that of aluminum, for example, stainless steel (SUS). Also, when the inner wall is surface-treated, the inner wall may be treated so that the inner wall has a thermal emissivity of 0.7 to 0.99.

In addition, the present invention is not limited to one example of the vacuum transfer chamber 103 according to the above-described embodiment, and, for example, a surface having a heat-absorbing coating formed therein may be used as the heat-absorbing surface, wherein the heat-absorbing coating surface is composed of a composite or a stacked film made of one or at least two compounds selected from quartz (SiO₂), aluminum nitride (AlN) or aluminum oxide (Al₂O₃). Also, the heat-absorbing surface may be a surface in which a black quartz or black ceramic cover is formed or a black quartz film or a black ceramic film is formed. Also, different materials may be combined according to a region of the inner wall of the vacuum transfer chamber.

Also, in the above-described embodiments, the use of the substrate processing apparatus in which the vacuum transfer robot 112 and the flange surface 115a are electro-polished has been described, but an arm and a flange of the vacuum transfer robot may be formed of a material having strength substantially identical to or higher than that of aluminum, for example, stainless steel (SUS). Also, when the arm or the flange is surface-treated, the arm or the flange may be treated, for example, mechanically polished, so that the arm or the flange has a thermal emissivity of 0.01 to 0.1.

Also, the present invention is not limited to an example of the arms 303 and 304 according to the above-described embodiment. In addition to or in substitution of the electropolishing or mechanical polishing, for example, a surface having a heat-reflecting coating formed therein may be used as a heat-reflecting surface, wherein the heat-reflecting coating surface is composed of one film made of gold (Au), silver (Ag), platinum (Pt), titanium (Ti), copper (Cu), aluminum (Al) or rhodium (Rh), or a compound thin film made of at least two elements. Also, a surface having a heat-reflecting coating formed therein may be used as a heat-reflecting surface, wherein the heat-reflecting coating is formed by stacking a SiO₂ thin film with one film made of Au, Ag, Pt, Ti, Cu, Al or Rh, or a compound thin film made of at least two elements. When the metal film is formed on a polished surface, a minute concavo-convex surface of the arm is filled up. Therefore, a flatter surface may be realized, and heat may be more easily reflected.

In addition, the present invention is not limited to an example of the arms 303 and 304 according to the above-described embodiment, and when the arms are made of a material such as aluminum, a surface of an aluminum solid material (aluminum solid) itself, that is, a metal-exposed surface itself, may be used as a heat-reflecting surface without performing a process such as polishing. Also, the different material may be combined according to a region of the arm. Also, when a reflective plate is installed on the entire arm, or particularly, a region that is easily susceptible to thermal radiation, a surface of the reflective plate may be considered to be used as a heat-reflecting surface, or a refrigerant channel may be installed in the arm. However, when the heat-reflecting surface is formed using the material or surface treatment of the arm, as described above, simplicity and lightness of a structure may be promoted.

Also, in the above-described embodiments, at least parts of the surfaces of the arms 303 and 304 are formed as the heat-reflecting surfaces. In this case, a surface that may easily receive radiant heat from the substrate 200, for example, an upper surface of the arm, may be used as a heat-reflecting surface, and a surface that may not easily receive radiant heat from the substrate 200, for example, a lower surface of the arm, may be used as a heat-emitting surface that is easily susceptible to thermal radiation. For example, a surface having an aluminum-anodized film thereon may be used as the heat-emitting surface, that is, a surface having the same configuration of the heat-absorbing surface of the vacuum transfer chamber 103 may be used. Therefore, heat may be reflected on the upper surface of the arm that may easily receive heat from the substrate 200, and even when heat is applied to the arm, the heat may be emitted from the heat-emitting surface formed on the lower surface of the arm, thereby suppressing an increase in temperature.

Also, when a distance between the lower surfaces of the arms 303 and 304 and the bottom surface of the vacuum transfer chamber 103 is shorter than a distance between the upper surfaces of the arms 303 and 304 and the ceiling surface of the vacuum transfer chamber 103, a collision rate between gas molecules close to the vacuum transfer chamber 103 and gas molecules on the lower surfaces of the arms 303 and 304 may be improved, and an efficiency of thermal radiation from the lower surfaces of the arms 303 and 304 may be improved. Also, an efficiency of heat transfer to the bottom surface of the vacuum transfer chamber 103 may be improved, and an increase in temperatures of the arms 303 and 304 may be suppressed.

Also, in the above-described embodiments, it is described that both sides of each of the arms 303 and 304 have a suitable configuration to suppress an increase in temperature of the heat-reflecting surface, but only the arm configured to transfer the processed substrate 200 may have this configuration, and the substrate 200 may be supported and transferred by the arm having such a configuration even in the unloading process.

Further, the configurations and specific shapes of the vacuum transfer chamber 103 having a cooling unit, the vacuum transfer chamber 103 having a heat-absorbing surface formed at the inner wall thereof, and the vacuum transfer robot 112 having a heat-reflecting surface formed at the surfaces of the arms 303 and 304 may be used alone or in combinations thereof. In any case, the substrate processing process has effects as described above. Therefore, even when the inner wall of the vacuum transfer chamber is electro-polished in a state where the inner wall is exposed to the aluminum solid as known in the art, or when the arm having a heat-reflecting surface which is exposed to the aluminum solid is used, a predetermined effect to suppress an increase in temperature may be achieved.

When at least one of the configurations is used, the number of substrates processed per hour, that is, throughput, may at least meet a specification of 50 sheets/h during the transfer of the substrate 200 having a temperature of 500° C. or higher. Also, a stricter specification, for example, throughput during the transfer of the substrate 200 having a temperature of 700° C. or higher, may meet a specification of 100 sheets/h.

### (1) First Example

An operation of carrying the substrate, which has been processed and heated at 700° C. in the process chamber having the same configuration as the process chambers 201a through 201d, into the preparatory chamber for unloading using one arm (an arm configured to transfer a processed substrate) of the vacuum transfer robot under an environment where a pressure in the vacuum transfer chamber was 100 Pa was performed 25 times using the same sequential order and techniques as in the above-described substrate processing process.

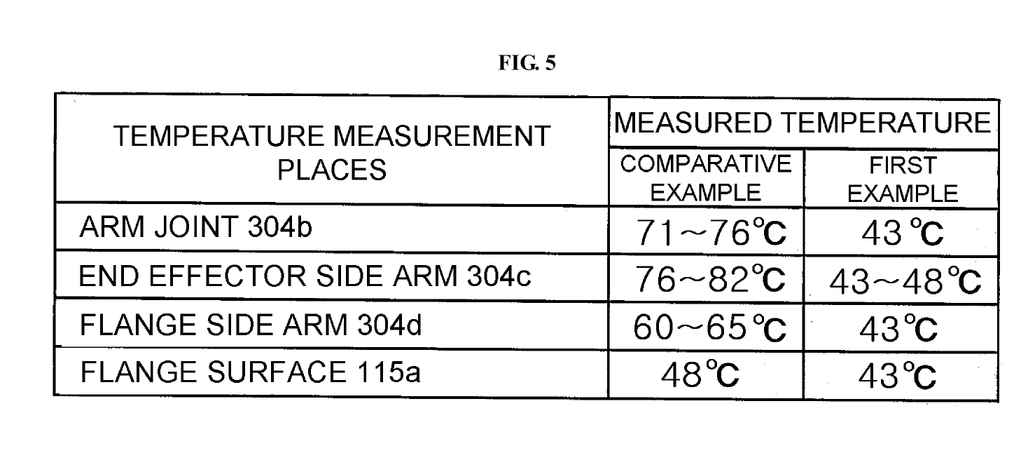

In this case, for a configuration of the first example in which the surface of the arm was electro-polished and the surface of the inner wall of the vacuum transfer chamber was treated with alumite, and a configuration of a conventional device, that is, a configuration of Comparative Example in which the surface of the arm was treated with alumite and the surface of the inner wall of the vacuum transfer chamber was exposed to aluminum solid, a temperature of each part of the vacuum transfer robot was measured by a thermo label. These temperature measurement results are shown in FIG. 5.

Referring to FIG. 5, it can be seen that the measured temperatures were low when the vacuum transfer robot according to this embodiment was used in all temperature measurement places. In particular, the measured temperature was reduced by 10° C. or higher in the places corresponding to the arm joint 304b, the end effector side arm 304c and the flange side arm 304d in the above-described embodiment, and also reduced by 5° C. in the place corresponding to the flange surface 115a. Therefore, it can be seen that thermal absorption of each part of the vacuum transfer robot may be lowered.

### (2) Second Example

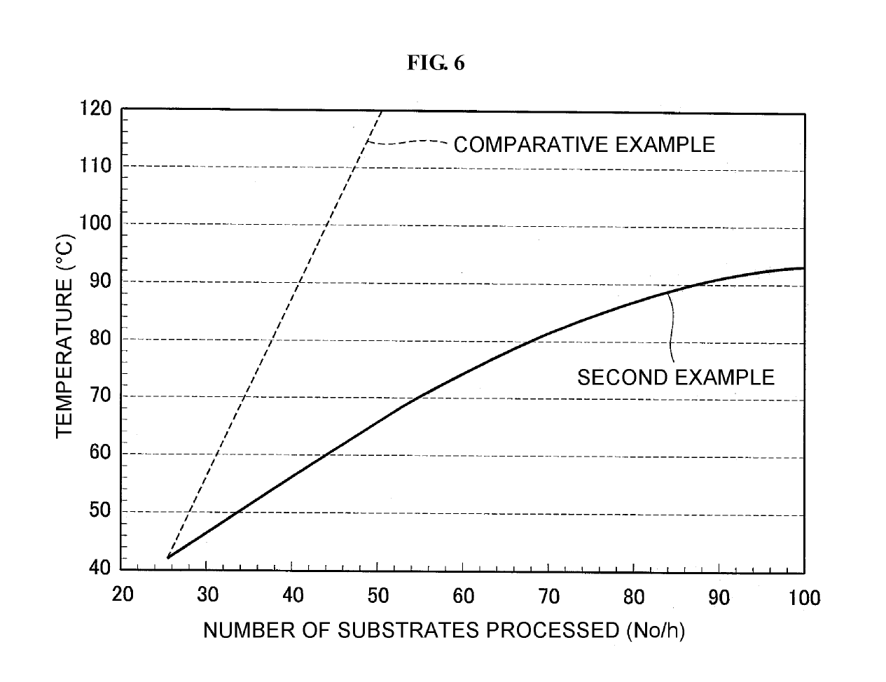

For the second example having the same configuration as the first example, and this Comparative Example having the same configuration as said Comparative Example, a temperature of each part of the vacuum transfer robot when an operation number per hour was set to 25 and 37 was measured using the same sequential order and techniques as the first example. Like the above-described embodiment, the transferred substrate was heated at 700° C., and a pressure in the vacuum transfer chamber was set to 100 Pa. Therefore, it was realized that a mean temperature of each part of the vacuum transfer robot was dependent on the number of transfers per hour, as shown in FIG. 6.

In FIG. 6, a horizontal axis represents a number of operations per hour, or a number of substrates processed (sheet(s)/h), and a vertical axis represents a mean temperature (° C.) of each part of the vacuum transfer robot. In the drawings, the mean temperature of each part of the vacuum transfer robot according to Comparative Example is represented by a dashed line. In the drawings, a numerical value in an operation number (number of substrates processed) exceeding measured points is also obtained by extrapolating a numerical value expected from the measured data.

Referring to FIG. 6, a temperature obtained when 50 substrates were transferred was expected to exceed an operation limit temperature of 120° C. in the vacuum transfer robot of Comparative Example. In this regard, it can be seen that the temperature of the vacuum transfer robot of this embodiment was approximately 66° C., and a thermal absorption of the vacuum transfer robot was reduced in this embodiment. Also, in the configuration of this embodiment, although the substrates were processed after the number of transfers was increased to 100 sheets/h, a temperature of the vacuum transfer robot was 94° C., thereby processing 100 substrates per hour. Therefore, a number of substrates processed per hour may be increased.

### (3) Third Example

Each part of the vacuum transfer robot when a number of operations per hour was changed to a maximum of 75 based on the same sequential order and technique as in the second example was measured for temperature. The transferred substrate was heated at 700° C., and a pressure in the vacuum transfer chamber was adjusted to 100 Pa. In this case, the surface of the arm was electro-polished in the third example, a configuration where a surface of the inner wall of the vacuum transfer chamber was exposed to aluminum solid was used as a first configuration, and a configuration where a surface of the inner wall of the vacuum transfer chamber was treated with alumite was used as a second configuration. This Comparative Example had the same configuration as said Comparative Example.

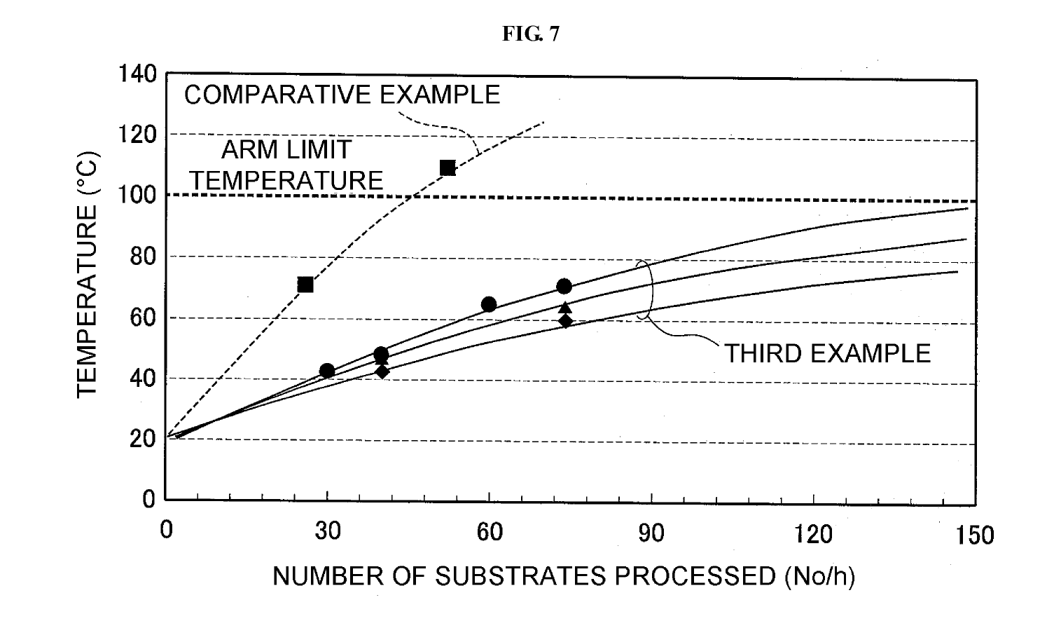

Therefore, in each configuration, it was realized that a temperature in a predetermined place where the vacuum transfer robot was provided was dependent on the number of substrates processed per hour, as shown in FIG. 7. In the drawings, a symbol “▪” represents the results obtained by measuring a temperature of a place corresponding to the end effector side arm 304c of the above-described embodiment in the configuration of Comparative Example. Also, a symbol “” represents the results obtained by measuring a temperature of a place corresponding to the arm joint 304b of the above-described embodiment in the first configuration of the third example. Also, a symbol “▴” represents the results obtained by measuring a temperature of a place corresponding to the arm joint 304b of the above-described embodiment in the second configuration of the third example. A symbol “♦” represents the results obtained by measuring a temperature of a place corresponding to the end effector side arm 304c of the above-described embodiment in the second configuration of the third example.

As shown in FIG. 7, the data of this embodiment based on the measured value has a lower value than the data of the second example based on the above-described extrapolation value. Also, according to a first configuration of this embodiment, it can be seen that, since the inner wall of the vacuum transfer chamber is conventionally made of aluminum solid, a temperature of the arm may be lowered by electropolishing a surface of the arm. In this case, when a number of substrates processed per hour is 50 sheets, the arm of this embodiment has a lower temperature than the arm of Comparative Example by approximately 40° C. to 50° C. Also, a temperature of the arm may be lowered by approximately 10° C. by treating the inner wall of the vacuum transfer chamber with alumite

In this embodiment, after a specification value of an arm limit temperature is set to 100° C. or lower, it was analyzed from the graph of FIG. 7 whether or not a specification value of desired throughput (number of substrates processed) met 100 sheets/h. As a result, in the case of the measured value when the number was 75 sheets/h, and an extrapolation value when the number was 100 sheets/h, a temperature of each part of the arm was lower than 100° C., and met the specification value in any configuration of the third example.

### Preferred Embodiment of the Present Invention

Hereinafter, preferred embodiments of the present invention will be additionally stated.

### [Supplementary Note 1]

One embodiment of the present invention provides a substrate processing apparatus, including:

a transfer chamber having a substrate transferred thereinto under a negative pressure;

a process chamber connected to the transfer chamber and configured to heat the substrate;

a transfer robot installed in the transfer chamber and configured to transfer the substrate into and out of the process chamber; and

a cooling unit configured to cool an inner wall of the transfer chamber.

### [Supplementary Note 2]

The substrate processing apparatus according to Supplementary Note 1, wherein the cooling unit preferably includes a refrigerant channel installed in a wall of the transfer chamber.

[Supplementary Note 3]

The substrate processing apparatus according to any one of Supplementary Notes 1 and 2, wherein the cooling unit also preferably includes at least one of a heat exchanger installed at an outer wall of the transfer chamber, and an air blower configured to blow a gas to the outer wall of the transfer chamber from an outside.

### [Supplementary Note 4]

The substrate processing apparatus according to any one of Supplementary Notes 1 through 3, wherein a surface of the inner wall of the transfer chamber is also preferably a heat-absorbing surface having an aluminum-anodized film thereon,

the transfer robot includes an arm configured to support the substrate, and

at least a portion of a surface of the arm is an electro-polished heat-reflecting surface.

### [Supplementary Note 5]

The substrate processing apparatus according to Supplementary Note 4, wherein the cooling unit is also preferably configured to cool a bottom surface of the transfer chamber substantially opposite to a lower surface of the arm.

### [Supplementary Note 6]

Another embodiment of the present invention provides a substrate processing apparatus including:

a transfer chamber having a substrate transferred thereinto under a negative pressure;

a process chamber connected to the transfer chamber and configured to heat the substrate; and

a transfer robot installed in the transfer chamber and configured to transfer the substrate into and out of the process chamber,

wherein a surface of an inner wall of the transfer chamber is a heat-absorbing surface.

### [Supplementary Note 7]

The substrate processing apparatus according to Supplementary Note 6, wherein the heat-absorbing surface of the transfer chamber has at least one of an aluminum-anodized film, a black quartz film and a black ceramic film formed therein.

### [Supplementary Note 8]

The substrate processing apparatus according to any one of Supplementary Notes 6 and 7, wherein the heat-absorbing surface of the transfer chamber also preferably has a thermal absorptivity of 0.7 to 0.99 when thermal absorptivity of a black body is set to 1.0.

### [Supplementary Note 9]

Still another embodiment of the present invention provides a substrate processing apparatus including:

a transfer chamber having a substrate transferred thereinto under a negative pressure;

a process chamber connected to the transfer chamber and configured to heat the substrate; and

a transfer robot installed in the transfer chamber and configured to transfer the substrate into and out of the process chamber,

wherein the transfer robot includes an arm configured to support the substrate, and

at least a portion of a surface of the arm is a heat-reflecting surface.

### [Supplementary Note 10]

The substrate processing apparatus according to Supplementary Note 9, wherein the heat-reflecting surface of the arm is also preferably at least one of an electro-polished or mechanically polished surface, a metal-exposed surface of the arm made generally of a metal, and a surface of a reflective plate installed at the arm.

### [Supplementary Note 11]

The substrate processing apparatus according to any one of Supplementary Notes 9 and 10, wherein the heat-reflecting surface of the arm also preferably has a thermal absorptivity of 0.01 to 0.1 when thermal absorptivity of a black body is set to 1.0.

### [Supplementary Note 12]

The substrate processing apparatus according to any one of Supplementary Notes 9 through 11, wherein at least one of an upper surface of the arm configured to support the substrate and a surface receiving thermal radiation from an inside of the process chamber is also preferably the heat-reflecting surface.

### [Supplementary Note 13]

The substrate processing apparatus according to any one of Supplementary Notes 9 through 12, wherein the upper surface of the arm is also preferably the heat-reflecting surface, and a lower surface of the arm is a heat-emitting surface.

### [Supplementary Note 14]

Yet another embodiment of the present invention provides a substrate processing apparatus including:

a transfer chamber having a substrate transferred thereinto under a negative pressure;

a process chamber connected to the transfer chamber and configured to heat the substrate; and

a transfer robot installed in the transfer chamber and configured to transfer the substrate into and out of the process chamber,

wherein the transfer robot has an arm configured to support the substrate, and

at least a portion of a surface of the arm has a lower thermal absorptivity than a surface of an inner wall of the transfer chamber.

### [Supplementary Note 15]

Yet another embodiment of the present invention provides a substrate processing apparatus including:

a transfer chamber having a substrate transferred thereinto under a negative pressure;

a process chamber connected to the transfer chamber and configured to heat the substrate;

a transfer robot installed in the transfer chamber and configured to transfer the substrate into and out of the process chamber; and

a cooling unit configured to cool an inner wall of the transfer chamber, wherein a surface of the inner wall of the transfer chamber is a heat-absorbing surface.

### [Supplementary Note 16]

Yet another embodiment of the present invention provides a substrate processing apparatus including:

a transfer chamber having a substrate transferred thereinto under a negative pressure;

a process chamber connected to the transfer chamber and configured to heat the substrate;

a transfer robot installed in the transfer chamber and configured to transfer the substrate into and out of the process chamber; and

a cooling unit configured to cool an inner wall of the transfer chamber,

wherein the transfer robot includes an arm configured to support the substrate, and

at least a portion of a surface of the arm is a heat-reflecting surface.

### [Supplementary Note 17]

Yet another embodiment of the present invention provides a substrate processing apparatus including:

a transfer chamber having a substrate transferred thereinto under a negative pressure;

a process chamber connected to the transfer chamber and configured to heat the substrate;

a transfer robot installed in the transfer chamber and configured to transfer the substrate into and out of the process chamber; and

a cooling unit configured to cool an inner wall of the transfer chamber,

wherein the transfer robot includes an arm configured to support the substrate, and

at least a portion of a surface of the arm has a lower thermal absorptivity than a surface of an inner wall of the transfer chamber.

### [Supplementary Note 18]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer chamber having a substrate transferred thereinto under a negative pressure;

(b) heating the substrate in the process chamber; and

(c) unloading the substrate from the process chamber into the transfer chamber using the transfer robot,

wherein, at least in step (c), the substrate is unloaded while an inner wall of the transfer chamber is cooled by a cooling unit.

### [Supplementary Note 19]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer chamber having a substrate transferred thereinto under a negative pressure;

(b) heating the substrate in the process chamber; and

(c) unloading the substrate from the process chamber into the transfer chamber using the transfer robot,

wherein, at least in step (c), the substrate is transferred in the transfer chamber in which a surface of an inner wall is a heat-absorbing surface.

### [Supplementary Note 20]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer robot including at least one arm configured to support the substrate, the transfer chamber having a substrate transferred thereinto under a negative pressure;

(b) heating the substrate in the process chamber; and

(c) unloading the substrate from the process chamber into the transfer chamber using the transfer robot,

wherein, at least in step (c), the substrate is supported and transferred by the arm whose surface has at least a part formed therein as a heat-reflecting surface.

### [Supplementary Note 21]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer robot including at least one arm configured to support the substrate, the transfer chamber having a substrate transferred thereinto under a negative pressure;

(b) heating the substrate in the process chamber; and

(c) unloading the substrate from the process chamber into the transfer chamber using the transfer robot,

wherein, at least in step (c), the substrate is supported and transferred by the arm whose surface has at least a part formed therein to have a lower thermal absorptivity than a surface of an inner wall of the transfer chamber.

### [Supplementary Note 22]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer chamber having a substrate transferred thereinto under a negative pressure and

(b) heating the substrate in the process chamber; and

(c) unloading the substrate from the process chamber into the transfer chamber using the transfer robot,

wherein, at least in step (c), the substrate is transferred in the transfer chamber in which a surface of an inner wall is a heat-absorbing surface while the inner wall of the transfer chamber is cooled by a cooling unit.

### [Supplementary Note 23]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer robot including at least one arm configured to support the substrate, the transfer chamber having a substrate transferred thereinto under a negative pressure;

(b) heating the substrate in the process chamber; and

(c) unloading the substrate from the process chamber into the transfer chamber using the transfer robot,

wherein, at least in step (c), the substrate is supported and transferred by the arm whose surface has at least a part formed therein as a heat-reflecting surface while an inner wall of the transfer chamber is cooled by a cooling unit.

### [Supplementary Note 24]

Yet another embodiment of the present invention provides a method of manufacturing a semiconductor device, including:

(a) loading a substrate from a transfer chamber into a process chamber connected to the transfer chamber using a transfer robot installed in the transfer chamber, the transfer robot including at least one arm configured to support the substrate, the transfer chamber having a substrate transferred thereinto under a negative pressure;

(b) heating the substrate in the process chamber; and

(c) unloading the substrate from the process chamber into the transfer chamber using the transfer robot,

wherein, at least in step (c), the substrate is supported and transferred by the arm whose surface has at least a part formed therein to have lower thermal absorptivity than a surface of an inner wall of the transfer chamber while the inner wall of the transfer chamber is cooled by a cooling unit.

### [Supplementary Note 25]

Yet another embodiment of the present invention provides a substrate processing apparatus including:

a transfer chamber serving as a substrate transfer space;

at least one transfer robot installed in the transfer chamber and configured to transfer the substrate; and

a plurality of process chambers connected to the transfer chamber and configured to process the substrate,

wherein an inner wall of the transfer chamber and an arm of the transfer robot are surface-treated so that a surface of the inner wall of the transfer chamber has a higher thermal emissivity than a surface of the arm of the transfer robot.

### [Supplementary Note 26]

Yet another embodiment of the present invention provides a substrate processing apparatus including:

a transfer chamber serving as a substrate transfer space;

a transfer robot installed in the transfer chamber and configured to transfer the substrate; and

at least one process chamber connected to the transfer chamber and configured to process the substrate,

wherein an inner wall of the transfer chamber and an arm of the transfer robot are surface-treated such that a surface of the inner wall of the transfer chamber has a thermal emissivity of 0.7 to 0.99, and a surface of the arm of the transfer robot has a thermal emissivity of 0.01 to 0.1.

### [Supplementary Note 27]

Preferably, the surface treatment applied to the surface of the inner wall of the transfer chamber is oxidation.

### [Supplementary Note 28]

Also, preferably, the surface treatment applied to the surface of the transfer chamber is anodic oxidation treatment of aluminum.

### [Supplementary Note 29]

Also, preferably, an oxide thin film is stacked on the arm of the transfer robot.

### [Supplementary Note 30]

Also, preferably, the surface treatment applied to the surface of the arm of the transfer robot is electropolishing.

### [Supplementary Note 31]

Also, preferably, the arm of the transfer robot is made of stainless steel (SUS).

### [Supplementary Note 32]

Also, preferably, the surface of the arm of the transfer robot made of the SUS is subjected to the electropolishing.

### [Supplementary Note 33]

Also, preferably, a heat-reflecting coating film composed of one film made of gold (Au), silver (Ag), platinum (Pt), titanium (Ti), copper (Cu), aluminum (Al) and rhodium (Rh), or a compound film made of at least two elements is formed on the surface of the arm of the transfer robot.

### [Supplementary Note 34]

Also, preferably, a heat-reflecting coating film obtained by stacking a SiO₂ thin film with a thin film made of one of Au, Ag, Pt, Ti, Cu, Al and Rh or a compound film made of at least two elements is formed on the surface of the arm of the transfer robot.

### [Supplementary Note 35]

Yet another embodiment of the present invention provides a method of manufacturing a semiconductor device in a substrate processing apparatus characterized in that an inner wall of a transfer chamber and an arm of a transfer robot are surface-treated so that a surface of the inner wall of the transfer chamber has a higher thermal emissivity than a surface of the arm of the transfer robot, the method including:

transferring, at the transfer robot, a substrate to a heatable substrate support installed in at least one process chamber connected to the transfer chamber;

heating the substrate in the process chamber; and controlling, at a control unit, the transfer robot and the substrate support.

### [Supplementary Note 36]

Yet another embodiment of the present invention provides a method of manufacturing a semiconductor device, including:

transferring a substrate to a heatable substrate support from an inside of a transfer chamber which is surface-treated so that an inner wall of the transfer chamber serving as a substrate transfer space has a thermal emissivity of 0.7 to 0.99 using a transfer robot which is installed in the transfer chamber and whose arm is surface-treated so that a surface of the arm can have a thermal emissivity of 0.01 to 0.1; processing the substrate in at least one process chamber connected to the transfer chamber; and controlling, at a control unit, the transfer robot and the substrate support.

What is claimed is:

1. A substrate processing apparatus comprising:
a transfer chamber having a substrate transferred thereinto under a negative pressure;
a process chamber connected to the transfer chamber and configured to heat the substrate;
a transfer robot installed in the transfer chamber and configured to transfer the substrate into and out of the process chamber; and
a cooling unit configured to cool an inner wall of the transfer chamber.

2. The substrate processing apparatus according to claim 1, wherein a surface of the inner wall of the transfer chamber comprises a heat-absorbing surface.

3. The substrate processing apparatus according to claim 1, wherein the transfer robot comprises an arm configured to support the substrate, at least a portion of a surface of the arm comprising a heat-reflecting surface.

4. The substrate processing apparatus according to claim 2, wherein the transfer robot comprises an arm configured to support the substrate, at least a portion of a surface of the arm comprising a heat-reflecting surface.

5. The substrate processing apparatus according to claim 3, wherein at least one of an upper surface of the arm and a surface receiving thermal radiation from an inside of the process chamber is the heat-reflecting surface

6. The substrate processing apparatus according to claim 4, wherein at least one of an upper surface of the arm and a surface receiving thermal radiation from an inside of the process chamber is the heat-reflecting surface

7. The substrate processing apparatus according to claim 1, wherein the surface of the inner wall of the transfer chamber comprises a heat-absorbing surface having an aluminum-anodized film thereon,
the transfer robot includes an arm configured to support the substrate, at least a portion of a surface of the arm comprising an electro-polished heat-reflecting surface.

8. A method of manufacturing a semiconductor device, comprising:
(a) loading a substrate from a transfer chamber into a process chamber connected to the transfer chamber using a transfer robot installed in the transfer chamber, the transfer chamber having a substrate transferred thereinto under a negative pressure;
(b) heating the substrate in the process chamber; and
(c) unloading the substrate from the process chamber into the transfer chamber using the transfer robot,
wherein, at least in step (c), the substrate is unloaded while an inner wall of the transfer chamber is cooled by a cooling unit.

9. The method according to claim 8, wherein, at least in the step (c), the substrate is transferred in the transfer chamber where a surface of the inner wall is a heat-absorbing surface.

10. The method according to claim 9, wherein the transfer robot comprises at least one arm configured to support the substrate, and, at least in step (c), the substrate is supported and transferred by the at least one arm, at least a portion of a surface of the at least one arm comprising a heat-reflecting surface.

11. The method according to claim 8, wherein, the transfer robot comprises at least one arm configured to support the substrate, and at least in step (c), the substrate is supported and transferred by the at least one arm, at least a portion of a surface of the at least one arm comprising a heat-reflecting surface.

12. The method according to claim 10, wherein at least one of an upper surface of the at least one arm and a surface receiving thermal radiation from an inside of the process chamber is the heat-reflecting surface

13. The method according to claim 11, wherein at least one of an upper surface of the at least one arm and a surface receiving thermal radiation from an inside of the process chamber is the heat-reflecting surface

14. The method according to claim 8, wherein an surface of the inner wall of the transfer chamber comprises a heat-absorbing surface having an aluminum-anodized film thereon, the transfer robot includes an arm configured to support the substrate, and at least a portion of a surface of the arm comprising an electro-polished heat-reflecting surface.
